(19) United States
(12) Patent Application Publication
(10) Pub. No.: US 2019/0144170 A1
(43) Pub. Date: May 16, 2019

(54) Universal Storage Lid

(71) Applicant: Vsevolod Mouler, San Francisco, CA (US)

(72) Inventor: Vsevolod Mouler, San Francisco, CA (US)

(21) Appl. No.: 15/965,885

(22) Filed: Apr. 28, 2018

Related U.S. Application Data
(60) Provisional application No. 62/586,112, filed on Nov. 14, 2017.

(51) Int. Cl. B65D 43/02; B65D 51/24; A47J 47/02

(52) U.S. Cl. CPC B65D 43/0222; B65D 51/245; A47J 47/02; B65D 2543/00027; B65D 2543/00842; B65D 2543/00296; B65D 2543/00527; B65D 2543/00537; B65D 2543/00092

(57) ABSTRACT

Embodiments are described for a universal food storage device having a main portion with a perimeter thereabout. An annular ring is molded thereto having a plurality of handles positioned at its edge. The device is configured to sealingly engage a vessel and preserve the contents therein.

### CROSS REFERENCE TO RELATED APPLICATIONS

This application claims priority to U.S. Provisional Application 62/586,112 titled “Stretchable Universal Lid” filed Nov. 14, 2017 which is hereby incorporated by reference.

### FIELD

The present invention generally relates to the field of kitchenware, and in particular to reusable kitchen lids used to store and preserve goods.

### BACKGROUND

It is estimated the nearly 60 million tons of produce was wasted in the United States alone in 2017. This does not account for other types of food waste including meats, deli items, and leftovers from cooked meals. Food waste has been identified as the single largest component of American landfills. An improved means for storing food is needed as populations increase.

Advanced food preparation is a popular component of adult life, especially as social demands have resulted in less time for busy individuals to cook. This process also a popular way to save money, reducing waste and the frequency in which one eats at a restaurant.

Conventional storage lids are made of hard materials, thus requiring the exact matching dimensions and shape for the corresponding containers the lids are a part of. Often, lids and their containers are sold as a set or kit to ensure each lid corresponds with and fits perfectly to the container to ensure storage is adequate. While this system is certainly effective, it does not account for lost lids, or damaged lids which no longer form an airtight fit with the container.

More primitive methods exist which are also slightly more universal. Items such as plastic wraps and tin foil provide enough tension over a container to form an airtight seal. This method does not solve the issue of eliminating waste and in fact contributes thereto by subjecting the environment to harmful plastics and metals.

Prior art exists for food storage implements. U.S. Pat. No. 4,198,040 to Julius R. Colasent describes an adjustable lid for a pan including a central circular member and an annulus, annular ribbing and securing means between the central member and annulus including undercut slots on one and ears on the other.

U.S. Pat. No. 4,934,558 to Ky Vargas describes a multiple size disposable plastic cup lid comprising a fiat circular disk of plastic with a pre-molded lip on the outer circumference that engages to the top edge of a drinking cup during use and wherein a plurality of radial creases or hinges from the center of the circular disk to the outer circumference allows the lid to be folded about various pairs of creases thus forming various cone shaped configurations that fit a series of smaller discrete container sizes.

U.S. Pat. No. 6,105,811 to Greg Alfred describes an ergonomic cooking pan cover designed for fitting on and covering the top of various sizes of pots, pans and skillets for venting steam and preventing boil-over.

U.S. Patent Pub. No. 2011/0303667 to Neils E. Batista discloses a line of specially designed reusable plastic food storage lids that are stretched to accommodate virtually any container. In this disclosure, consumers do not need to store and manage a bevy of different lids for their plastic food containers. Offered in three simple sizes, small, medium, and large, the line is fabricated of a durable, expandable rubber material. As such, these lids accommodate a range of sizes from extra small containers ideal for storing dressings and sauces, to small and medium size containers used for storing side dishes or single serving meals, to large and extra-large containers for use in storing entire entrees and similar fare. The invention is produced in a variety of shapes including rectangular, square and circular, to name a few options.

While the aforementioned prior art described food storage lids, none disclose the optimal invention described herein.

Accordingly, there exists a need for a method and tool that provides a universal lid that can fit container multiple shapes and sizes. The present invention seeks to provide such a solution.

### SUMMARY OF THE INVENTION

Embodiments described herein provide for a food storage device having a main portion with a top side, a bottom side, and a first perimeter. An annular ring extends from the perimeter, while a plurality of handles extending outward from the annular ring. This configuration permits the device to be retained on a vessel.

In an embodiment, a knob is rotationally engaged with the top side. The knob may be further comprised of an indicator to designate a measurement such as a day of the week or similar measurement of time.

At least one handle has an aperture disposed thereon. This aperture permits the use of a mounting assembly which allows the device to be hung from a surface. The mounting assembly has a mount member which is affixed to a flat vertical surface such as a wall, cabinet, or refrigerator. A retainer extends from the mount and is configured to be positioned through the aperture.

Preferentially, the device is provided as one of a set or kit. The set or kit includes a variety of sizes for the device to engage a variety of vessel configurations and sizes.

It is intended that the device be utilized to preserve foodstuff within a vessel providing a universal lid to a variety of containers and vessels used in the arts. The universal lid results in a hermetically sealed engagement with the vessel.

A method is described for storing food wherein a user selects an appropriate size device. Typically, this is a device having a diameter or dimension slightly smaller than the diameter or dimension of the container. The device is secured about the container and stored as typically performed in the arts. To remove the lid, the user may pull on at least one of the handles in a vertical direction to remove the lid.

It is preferred that the material utilized be resilient to high and low temperatures commonly used in food preservation and preparation such as temperatures between −50° and 500° Fahrenheit.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a top plan view of the lid, according to an embodiment of the present invention;

FIG. 2 illustrates a perspective view of the lid, according to an embodiment of the present invention;

FIG. 3 illustrates a cutaway view of the ridges of the lid, according to an embodiment of the present invention;

FIG. 4 illustrates a perspective view of the knob on the top surface of the lid, according to an embodiment of the present invention;

FIG. 5 illustrates an auxiliary assembly for hanging a plurality of lids, according to an embodiment of the present invention;

FIG. 6 illustrates an alternatively sized lid, according to an embodiment of the present invention;

FIG. 7 illustrates a set or kit comprised of a plurality of lids, according to an embodiment of the present invention; and

FIG. 8 illustrates the device affixed to a vessel, according to an embodiment of the present invention.

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantage's” provided by some embodiments, other embodiments may not include those same advantages, or may include different advantages. Any advantages described herein are not to be construed as limiting to any of the claims.

Before describing in detail exemplary embodiments, it is noted that the embodiments reside primarily in combinations of components related to the system. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terns, such as “first” and “second,” “top” and “bottom,” and the like, may be used solely to distinguish one entity or element from another entity or element without necessarily requiring or implying any physical or logical relationship or order between such entities or elements.

Specific quantities, dimensions, spatial characteristics, compositional characteristics and performance characteristics may be used explicitly or implicitly herein, but such specific quantities are presented as examples only and are approximate values unless otherwise indicated. Discussions and depictions pertaining to these, if present, are presented as examples only and do not limit the applicability of other characteristics, unless otherwise indicated.

In general, the present invention relates to a flexible and reusable lid device 100 to sealingly engage a food storage vessel. While the invention is described herein with reference to food storage covers for covering containers such as bowls, pots, and pans, it is to be understood that the teachings of the disclosure could be employed for any type of cover, such as but not limited covers used to store perishable goods and nonperishable goods. The device 100 is constructed of a sufficiently flexible material, it is contemplated that a plastic or thermoplastic material is used to prevent deterioration and degradation at high temperatures. The round natural shape of the device allows for it to be stretched over containers of many shapes and sizes. The material allows for safe food heating via a microwave oven, conventional oven, as well as storage in a freezer. The suitable material has a safe temperature range of −40° to 446° Fahrenheit.

In an embodiment, the device 100 may be made of an elastomeric material having the property of being resiliently stretchable for the anticipated range of vessels. In the preferred embodiment, the main portion 1 and gripping zone 14 are typically comprised of an elastomeric material. The elastomeric material may fit around a vessel constructed of glass, ceramic, metal, plastics, cans, and jars, in addition to other materials known in the arts. Further, the device may be retained on a fruit or vegetable such as a halved melon, grapefruit, or other produce.

A suitable elastomeric material can include silicone. This material is beneficial as it is sufficiently flexible and able to be exposed to a wide range of temperatures. The silicone may be free of BPA and is approved by the FDA and LFGB. Silicone also provides an easy to clean surface, reducing time and resources during the cleaning process.

In an embodiment of the invention, the device formed from a substantially bendable material that maintains the shape that is configured for the bendable material. For example, the device may be formed from silicone (or silicone rubber or polydimethylsiloxane) or another suitable silicon polymer with rubber-like properties. As known to those skilled in the relevant art(s), silicone rubber is a polymer of silicon-containing carbon, hydrogen and oxygen. Silicone rubber has excellent insulating and temperature-resistant properties. Silicone rubber is made through a process known as vulcanization or curing of natural rubber. Silicon is injected into the long hydrocarbon chains of natural rubber through a dual-stage process under high heat and pressure, thus converting it into silicone rubber. Additionally, the cured rubber is processed with additional steps until the final marketable product is obtained. Silicone rubber maintains all of its properties even at high temperatures of approximately 500 degrees Celsius as well as at low temperatures around −55 degrees Celsius. The silicon-carbon bonds in silicone rubber are resistant to temperature fluctuations. Additionally, silicone rubber exhibits better tear strength, tensile strength, elongation and compression in comparison to natural rubber at high temperatures. To provide added rigidity to the device and decreased elasticity to the device, a suitable amount of sulfur is added to the liquid rubber during the manufacturing process. If rigidity is added to (and elasticity is decreased for) the silicone used to form the device. Other standard steps known to those skilled in the relevant art(s) for setting the characteristics of silicone may be used in the bendable device.

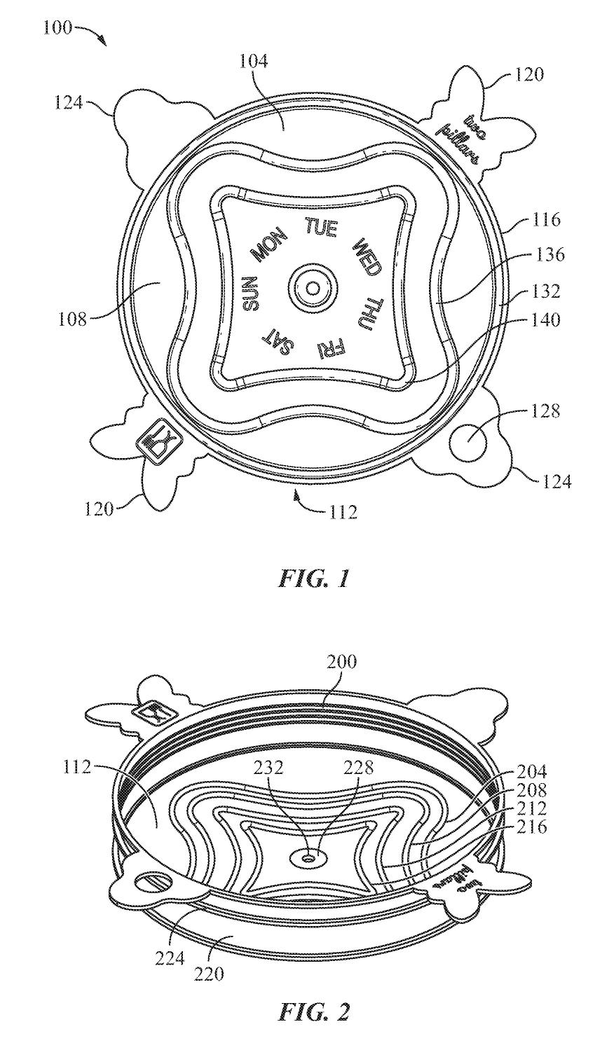

The present invention is depicted in FIG. 1, which shows the top view of the device 100 in an assembled configuration. A main portion 104 having a geometric shape such as a circle, square, or any other shape which corresponds to a vessel forms the lid of the device 100. The main portion 104 has a top side 108 and a bottom side 112 (see FIG. 2). A plurality of annular rings 136, 140 are molded on main portion. In an embodiment, each annular ridge 136, 140 may be concentric. The main portion has a first perimeter 116 defining a lateral edge of the device 100. A primary annular ring 132 is molded medial to the first perimeter 116 and configured to engaged with a rim of a vessel wherein the foodstuff is stored.

Preferentially, the top side 108 is matted during the production process to provide a unique aesthetic as well as a non-slip surface.

In reference to FIG. 2, the bottom side 112 of the device is illustrated in a perspective view illustrating the annular ring 220 and ridges 200 thereon. The annular ring has an interior side and an exterior side. The interior side has the plurality of ridges 200 molded thereon. The exterior side has a circumferential molding 224. The circumferential molding 224 may function as a grip portion for a user to increase friction as the user lifts the lid and container disposed thereon.

Friction between the annular ring and the vessel should be sufficient to prevent the leakage of fluids from the vessel.

In an embodiment, the device 100 is comprised of a central axis 232. As illustrated in FIG. 4, the central axis 232 may function as an axis of rotation for a removably engaged knob 404 positioned on the top side 108 of the main portion 104. The knob 404 may also be rotationally engaged via a central member 400 extending from the central axis 232 on the opposing side. An indicator 408 may be affixed, engaged, or molded to circumference of the knob. In a preferred embodiment, abbreviations for days of the week or another measurement of time 412 are printed, engraved, molded, or otherwise provided on the top side 108 of the device 100. This permits the user to rotate the knob 404 having the indicator 403 to a specific measurement of time. Time measurements may be utilized as a package date, best-by date, or intended use date such as the day of the week the user intends to consume the contents stored in the vessel. In this manner, the knob, indicator, and measurement of time are utilized as a dial.

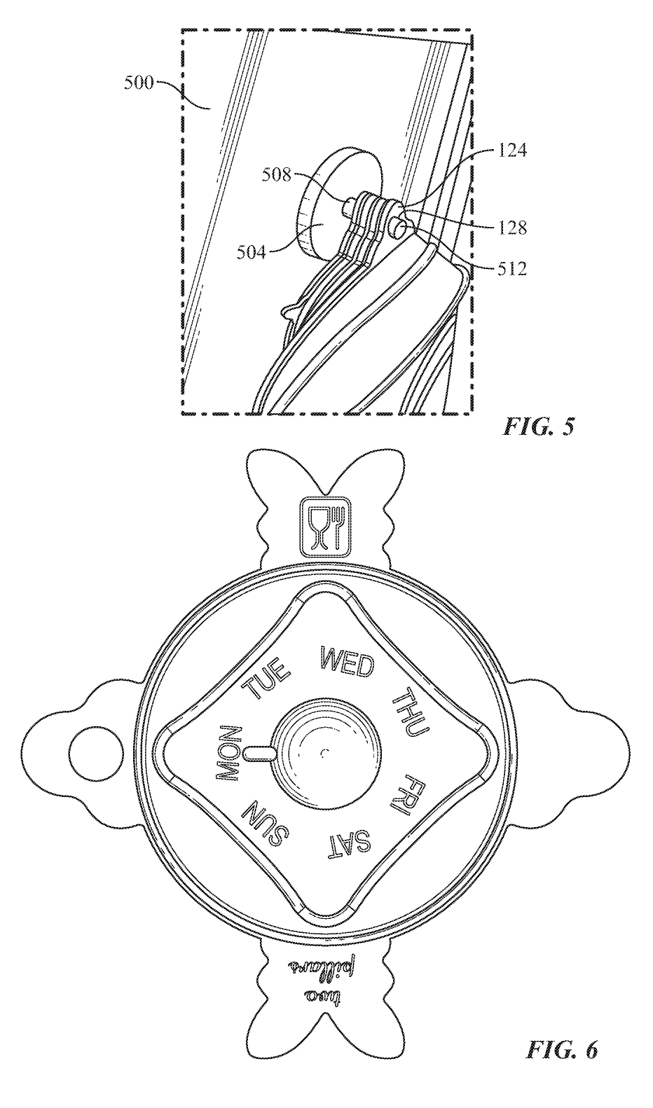

In a preferred embodiment, a plurality of handles 120, 124 extend from the second perimeter of the annular ring 220. At least one handle 120, 124 is comprised of a mounting aperture permitting the device 100 to be hung from the mounting assembly (see FIG. 5).

Removing the knob provides a flat surface on the top of the lid for stacking. In alternate embodiments, a knob substantially more planar with the surface of the lid may be utilized to promote more efficient stacking of the lids.

In an alternate embodiment, each handle may be constructed as a locking mechanism as currently utilized in the arts. In an example, the handle may be engaged via a hinge mechanism. The handle may have a locking clip or snap mechanism to lock the mechanism to the vessel.

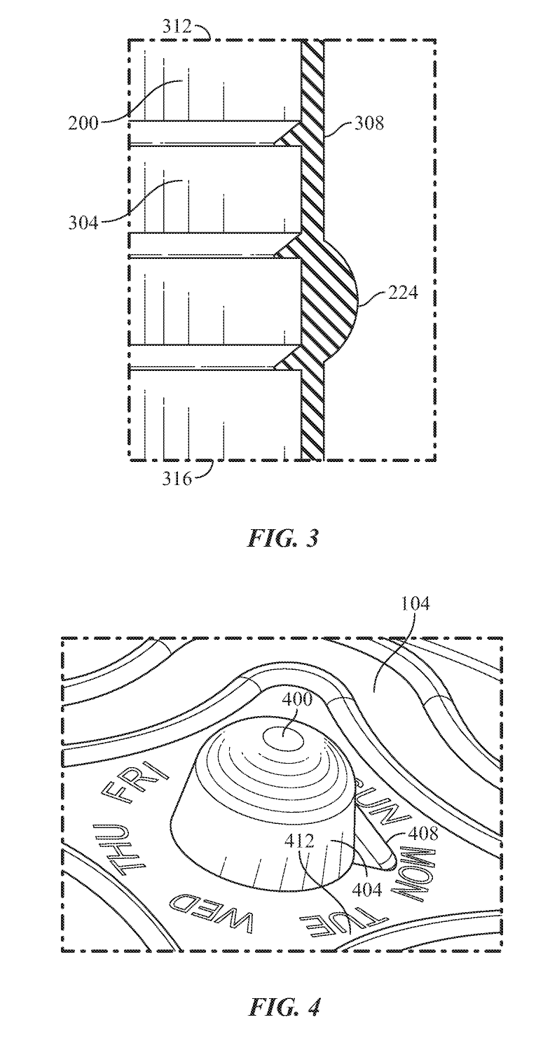

Now referring to FIG. 3, a cutaway view of the annular ring 220 is illustrated having a plurality of ridges 200 on its interior side 304. Each ridge protrudes from the interior side 304 and surface thereof to increase friction between the device 100 and the vessel it is engaged with. Each ride has a first surface extending substantially perpendicular from the surface, with a second surface extending tangentially from the surface. The second surface is oriented nearmost the top 312 while the first surface is positioned nearmost the bottom 316 of each ridge 200. This ensures the device 100 maintains a sealed engagement during storage and transportation of the vessel.

In reference to FIG. 5 the mounting assembly 500 is illustrated in an embodiment of the present invention. In a preferred embodiment, the assembly 500 is comprised of a mount 504 affixed to a surface such as a wall, a side of a cabinet, refrigerator, or other vertical and flat surface. The mount 504 may be removably engaged with engagement means such as an adhesive, magnetic component, or fastener as commonly used in the arts. The mount may also be permanently affixed to the surface using a fastener or similar implement known in the arts. A retainer 508 extends substantially perpendicular from the mount 504 and is configured to extend through the aperture 128 positioned on the handle 124. An end member 512 may be positioned at the distal end of the retainer 508 to ensure the device 100 is retained thereon during storage.

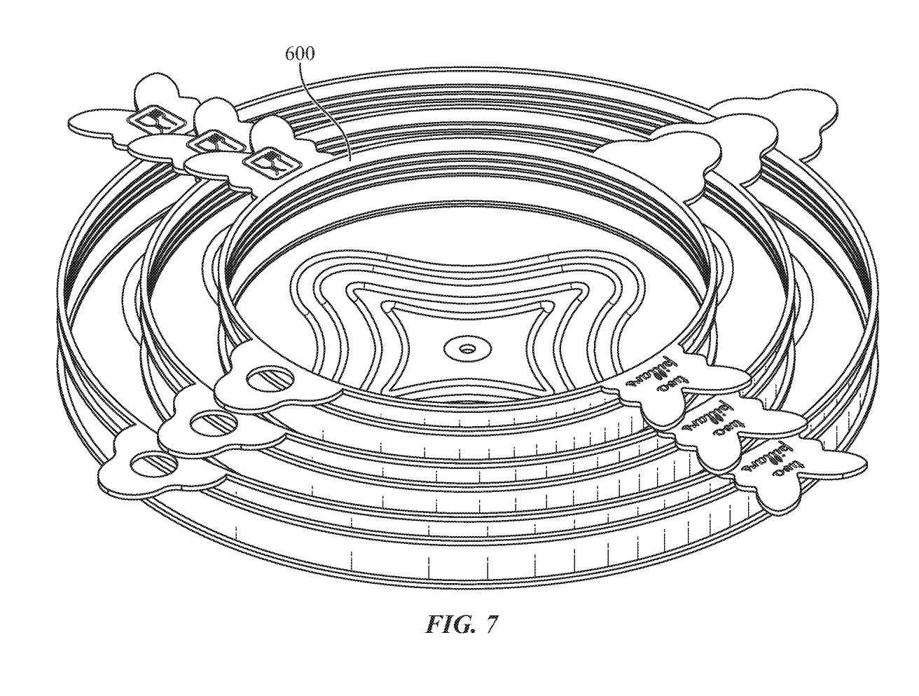

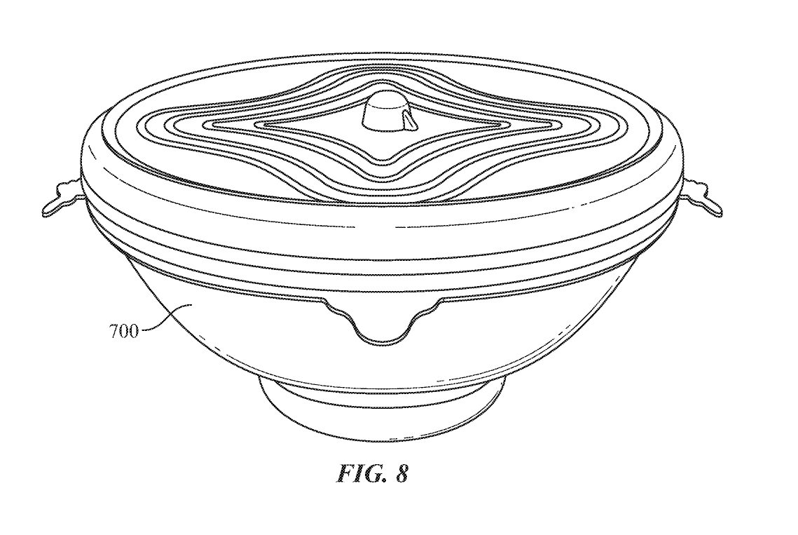

FIG. 6 illustrates an alternate embodiment of the device 100 having a smaller diameter than the device illustrated in FIG. 1 and FIG. 2. The device illustrated in FIG. 6 may be one of the set or kit as illustrated in FIG. 7 and described herein.

In a preferred embodiment, the device 100 has a plurality of ridges protruding from the inner surface. The ridges in tandem with the flexible and stretchable nature of the device result in an airtight seal between the device and the container having foodstuff therein. Each ridge has an internal side having an internal lip extending at a 90° angle therefrom. The internal lip is configured to collapse and sufficiently contact the outer surface of the container to result in the airtight seal.

In an embodiment, the device 100 may be manufactured by standard manufacturing methods known to those skilled in the relevant art(s) such as, by way of example and not by way of limitation, molding, stamping, extrusion processing, casting, polymer foam processing and forming, and/or other standard shaping processes of synthetic materials.

In an embodiment material utilized for the device in ay be polished smooth for aesthetic purposes as well as textured to aid in friction necessary to ensure a proper grip during transportation.

As a result of the shape of the invention, multiple devices 100 can be stacked atop one another with little space requirements. An example of a set or kit 600 including the inventions is illustrated in FIG. 7, wherein the stackability of the device 100 is illustrated.

In an embodiment, the set or kit 600 may be comprised of five lids of varying shapes ranging in diameter from about 6.5 cm to 21 cm. In an example, a first lid having a diameter of 21 cm is positioned on the bottom of a stack having a second lid with a diameter of 16.5 cm nested therein. A third lid having a diameter of 12 cm is nested within the second lid while a fourth lid with a diameter of 9.5 cm is nested within the third. Similarly, a fifth lid with the smallest diameter of 6.5 cm is nested within the fourth lid, forming a single stack of all five lids nested within one another.

In alternate embodiment, standard utility sizes can be used for various plastic, glass, metal and wooden bowls and tubs. Small diameter sizes can be used for enclosures for cups, canned foods, soda cans, condiment containers, and jars. Stopper sizes can be used as corks, bottle lids, and the like. Sheet forms can be used to laminate and seal foods such as meats, cheeses, and other perishables. Compliant lids according to the invention are configured to seal at least two different containers that differ from each other by container opening size (e.g., in terms of diameter), for example by 5% or more, 10% or more, 20% or more, 25% or more, 50% or more, 75% or more, 100% or more, etc. While the diameter or length of the container that the lid is configured to cover may vary, in some instances the lid may be configured to cover a container having a diameter or length ranging from 5 cm to 60 cm, such as 10 cm to 50 cm and including 15 cm to 35 cm, for example. The thickness of the lid may range from 0.2 cm to 2.0 cm, such as 0.5 cm to 1.5 cm and including 0.75 cm to 1 cm.

In an embodiment, while the set or kit may be comprised of devices 100 having varying diameters, the annular ring is similarly sized for each device in the kit. The height of the annular rings ensures adequate friction to prevent the device 100 from slipping off of the vessel.

The material may be substantially transparent, as well as opaque or having a color. Each altered color, texture, or clarity of the device may correspond to a food group therein, further providing the user with means for organizing their diet. This may be used in conjunction with the knob and indicator to provide means for scheduling and organization.

During use and in reference to FIG. 8, a user first disposes foodstuff into a vessel 700 dimensioned to receive the volume of food stuff to be stored. The user may then procure the device corresponding to the diameter or dimension of the vessel 700. To ensure an airtight fit, the user may select a device from the set or kit having a diameter or dimension slightly smaller than the diameter or dimension of the vessel. In this manner, the user may then stretch the device over the rim of the vessel, thus securely fitting the device thereon. The device may be removed by pulling substantially upwardly on at least one handle 120, 124.

One skilled in the arts will appreciate that the device is not limited to its use for sealing foodstuff within a container. The device may be utilized for sealing a paint can or similar household item to control the excretion of fumes therefrom. Further, the device may prevent the circulation of oxygen reacting with the household item therein to preserve for future use.

Further, the device may be utilized as a means for enhancing grip on a closed and container. The materials used provide significant friction for opening a sealed lid in a kitchen environment which may be wet.

In yet another use, the thermodynamic properties of the device allow it to be utilized as a heat shield between a hot item or surface and the hand of the user.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A food storage device comprising:
a. a main portion having a top side, a bottom side, and a first perimeter;
b. an annular ring extending from the perimeter,
c. a plurality of handles extending from the annular ring;
wherein the main portion is configured to be retained on a vessel.

2. The device of claim 1, further comprising a knob rotationally engaged with the top side.

3. The device of claim 2, wherein the knob further comprises an indicator.

4. The device of claim 3, wherein the indicator indicates a measurement.

5. The device of claim 1, having an aperture on at least one of the plurality of handles.

6. The device of claim 1, having a plurality of annular ridges molded on the main portion.

7. A food storage device comprising:
a. a main portion having a top side, a bottom side, and a perimeter;
b. an annular ring extending from the perimeter having a second perimeter;
c. a plurality of handles extending from the second perimeter;
d. a plurality of annular ridges positioned on the bottom side of the annular ring;
wherein the main portion is configured to be retained on a vessel.

8. The device of claim 7, further comprising a knob rotationally engaged with the top side.

9. The device of claim 8, wherein the knob further comprises an indicator.

10. The device of claim 9, wherein the indicator indicates a measurement.

11. The device of claim 7, wherein each of the plurality of annular ridges are concentric.

12. The device of claim 7, having a mounting aperture on at least one of the plurality of handles.

13. The device of claim 7, further comprising a mounting assembly comprising:
a. a mount configured to be retained on a surface; and
b. a retainer extending from the mount,
wherein the mounting aperture receives the retainer of the device.

14. A food storage system comprising:
a. a food storage device comprising:
i. a main portion having a top side, a bottom side, and a perimeter;
ii. at least one annular ring extending from the perimeter having a second perimeter, wherein the annular ring has an interior side and an exterior side;
iii. a plurality of ridges molded to the interior side of the annular ring;
iv. a plurality of handles extending from the second perimeter, at least one of the plurality of handles comprising an aperture;
v. a mounting assembly having a mount and a retainer, wherein the aperture receives the retainer, wherein the mount is affixed to a surface; and
wherein the main portion is configured to be retained on a vessel via sufficient friction provided by the plurality of ridges.

15. The system of claim 14, further comprising the steps of:
a. procuring, via a user the vessel and the device;
b. disposing foodstuff within the vessel;
c. positioning the device over a rim of the vessel; and
d. storing the vessel.

16. The system of claim 15, wherein the device is procured from the mounting assembly.

17. The system of claim 14, further comprising a knob rotationally engaged with the top side.

18. The system of claim 17, wherein the knob further comprises an indicator.

19. The system of claim 18, wherein the indicator indicates a measurement.

20. The system of claim 14, wherein the device is provided as a part of a set or kit.
